(19) United States
(12) Patent Application Publication
(10) Pub. No.: US 2018/0026511 A1
(43) Pub. Date: Jan. 25, 2018

(54) VIBRATION MOTOR AND METHOD FOR MANUFACTURING THE SAME

(71) Applicant: Nidec Seimitsu Corporation, Ueda-shi (JP)

(72) Inventors: Tomohiro AKANUMA, Ueda-shi (JP); Mitsuru OI, Ueda-shi (JP); Yuuki YAMADA, Ueda-shi (JP)

(21) Appl. No.: 15/657,330

(22) Filed: Jul. 24, 2017

(30) Foreign Application Priority Data
Jul. 25, 2016 (JP) 2016-145468

(51) Int. Cl. H02K 35/02; H02K 33/18; H02K 33/16

(52) U.S. Cl. CPC H02K 35/02; H02K 33/16; H02K 33/18; H02K 15/14

(57) ABSTRACT

A vibration motor includes a stationary portion including a casing and a coil; a vibrating body including a weight and a magnet, the vibrating body being supported so as to be vibratable in one direction relative to the stationary portion; and an elastic member located between the stationary portion and the vibrating body. The magnet is disposed above the coil in an up-down direction that is perpendicular to the one direction. The weight includes a first side wall extending in the one direction and a second side wall facing the first side wall. The casing includes at least one first opening facing the first side wall and at least one second opening facing the second side wall.

### CROSS REFERENCE TO RELATED APPLICATIONS

This application claims the benefit of priority to Japanese Patent Application No. 2016-145468 filed on Jul. 25, 2016. The entire contents of this application are hereby incorporated herein by reference.

### BACKGROUND OF THE INVENTION

### 1. Field of the Invention

The present invention relates to a vibration motor and a method for manufacturing the vibration motor.

### 2. Description of the Related Art

Vibration motors have been used in various devices, such as smartphones. An example of existing vibration motors is disclosed in CN 202435225 U.

The vibration motor described in CN 202435225 U includes a vibrating body, which includes a weight and magnets, and a casing. An elastic member is disposed between the casing and the weight. The vibrating body is supported by the elastic member so as to be vibratable in one direction.

In a vibration motor, it is necessary to maximize the volume of a weight in order that the vibration motor can vibrate with sufficient amplitude. For this purpose, it is necessary to minimize the gap between the weight and the casing. However, with exiting technologies, it is not easy to precisely control such a small gap in a process of manufacturing the vibration motor.

### SUMMARY OF THE INVENTION

According to an exemplary embodiment of the present application, a vibration motor includes a stationary portion including a casing and a coil; a vibrating body including a weight and a magnet, the vibrating body being supported so as to be vibratable in one direction relative to the stationary portion; and an elastic member located between the stationary portion and the vibrating body. The magnet is disposed above the coil in an up-down direction that is perpendicular to the one direction. The weight includes a first side wall extending in the one direction and a second side wall facing the first side wall. The casing includes at least one first opening facing the first side wall and at least one second opening facing the second side wall.

According to an exemplary embodiment of the present application, there is provided a method for manufacturing a vibration motor. The vibration motor includes a stationary portion including a casing and a coil; a vibrating body including a weight and a magnet, the vibrating body being supported so as to be vibratable in one direction relative to the stationary portion; and an elastic member located between the stationary portion and the vibrating body. The magnet is disposed above the coil in an up-down direction that is perpendicular to the one direction. The weight includes a first side wall extending in the one direction and a second side wall facing the first side wall. The casing includes at least one first opening facing the first side wall and at least one second opening facing the second side wall. The method includes a first step of holding the weight by inserting protrusions of a jig into the first opening and the second opening; and a second step of fixing the elastic member and the casing to each other by welding in a state in which the weight is held.

With each of the exemplary embodiments of the present application, it is possible to easily control a gap between the weight of the vibrating body and the casing when manufacturing the vibration motor.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an exploded perspective view of a vibration motor according to a first embodiment of the present invention.

FIG. 2 is a plan view illustrating a state in which a weight is held by a jig when fixing an elastic member to a cover and the weight in the first embodiment.

FIG. 3A is a schematic plan view illustrating a method of fixing of an elastic member to a cover and a weight according to a comparative example.

FIG. 3B is a schematic plan view illustrating a method of fixing of the elastic member to the cover and the weight according to the first embodiment.

FIG. 4 is a perspective view of the vibration motor according to the first embodiment.

FIG. 5 is a bottom view of the vibration motor according to the first embodiment.

FIG. 6 is an exploded perspective view of a vibration motor according to a second embodiment of the present invention.

FIG. 7 is a plan view illustrating a state in which a weight is held by a jig when fixing an elastic member to a cover and the weight in the second embodiment.

FIG. 8 is a plan view illustrating a structure including a base and adjacent components according to the second embodiment seen from above.

FIG. 9A is a partial sectional view of the vibration motor taken along line IXA-IXA in FIG. 7.

FIG. 9B is a partial sectional view of the vibration motor taken along line IXB-IXB in FIG. 7.

FIG. 10 is a plan view illustrating a state in which a weight is held by a jig when fixing an elastic member to a cover and the weight in a modification of the second embodiment.

### DETAILED DESCRIPTION OF THE PREFERRED EMBODIMENTS

Hereinafter, exemplary embodiments of the present invention will be described with reference to the drawings.

### 1. First Embodiment

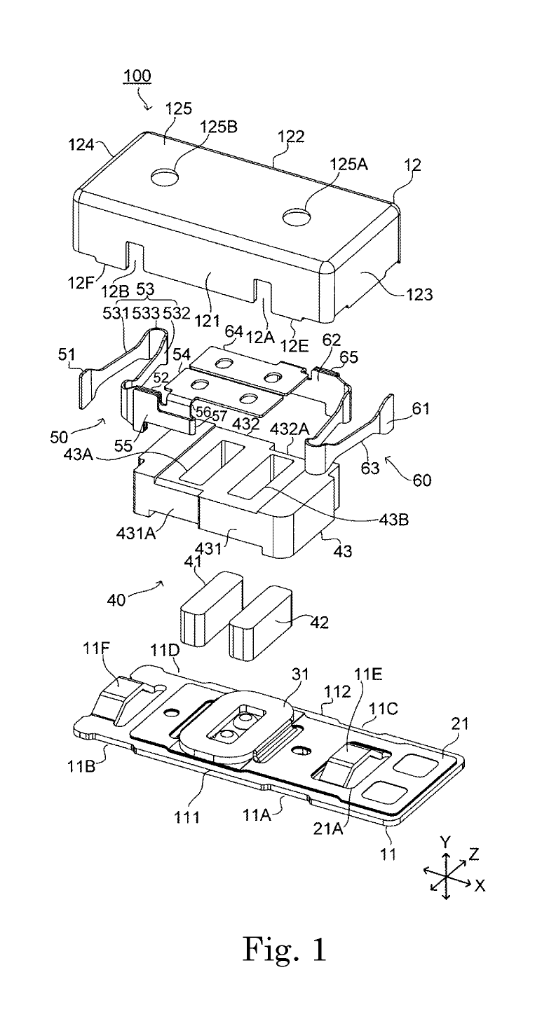

FIG. 1 is an exploded perspective view of a vibration motor according to a first embodiment of the present invention.

In FIG. 1, the left-right direction (one direction) is defined as a first direction, which is represented as the X-direction. The up-down direction, which is perpendicular to the first direction, is represented as the Y-direction. For example, in FIG. 1, upward along the plane of FIG. 1 is upward in the up-down direction (Y-direction). A second direction that is perpendicular to the first direction and the up-down direction is represented as the Z-direction. The same definitions apply to other figures. However, these definitions of directions do not apply to positional relationships and directions when the vibration motor is disposed in an actual device.

### 1-1. Overall Structure of Vibration Motor

A vibration motor 100 according to the present embodiment includes a base 11, a substrate 21, a coil 31, a vibrating body 40, an elastic member 50, an elastic member 60, and a cover 12. The vibration motor 100 includes a casing that includes the base 11 and the cover 12. The cover 12 includes a first side portion 121, a second side portion 122, a third side portion 123, a fourth side portion 124, and a top portion 125. The first side portion 121 extends in the first direction. The second side portion 122 faces the first side portion 121. The third side portion 123 extends in the second direction. The fourth side portion 124 faces the third side portion 123. A hole 125A and a hole 125B, which are arranged in the first direction, are formed in the top portion 125.

The substrate 21 is a rigid substrate, a flexible substrate, or the like. The substrate 21 is fixed to an upper surface of the base 11. The coil 31 is attached to an upper surface of the substrate 21. The coil 31 is bonded to the upper surface by, for example, using an adhesive. Alternatively, the coil 31 may be fixed to the substrate 21 by using a method other than adhesive bonding.

The casing, the substrate 21, and the coil 31 constitute a stationary portion. That is, the vibration motor 100 includes a stationary portion that includes the casing and the coil 31.

The vibrating body 40 includes magnets 41 and 42 and a weight 43. The weight 43 has hollow portions 43A and 43B. The weight 43 is made of, for example, a tungsten alloy. The hollow portions 43A and 43B extend through the weight 43 in the up-down direction. The magnet 41 is disposed in the hollow portion 43A. The magnet 42 is disposed in the hollow portion 43B. The magnets and 42 are disposed above the coil 31. Alternatively, the hollow portions 43A and 43B need not extend through the weight 43 in the up-down direction and may be recessed portions in which the magnets 41 and 42 can be disposed.

The weight 43 includes a first side wall 431 and a second side wall 432. The first side wall 431 extends in the first direction. The second side wall 432 faces the first side wall 431. The first side wall 431 has a step portion 431A in a part thereof in the one direction. The second side wall 432 has a step portion 432A in a part thereof in the one direction. The step portion 431A and the step portion 432A are disposed diagonal to each other.

The elastic member 50 includes a first fixing portion 51, a second fixing portion 52, a plate spring portion 53, a top plate portion 54, a flat plate portion 55, a first connection portion 56, and a second connection portion 57. These portions are integrated with each other. The plate spring portion 53 includes a first beam 531, a second beam 532, and a connection portion 533. The first beam 531, which has a flat plate-like shape, faces the second beam 532, which has a flat plate-like shape, in the first direction. The connection portion 533 connects an end portion of the first beam 531 to an end portion of the second beam 532. To an end portion of the second beam 532 away from the connection portion 533, an end portion of the second fixing portion 52 is connected. The second fixing portion 52 is bent in the first direction at a middle part thereof. The second fixing portion 52 is fixed to the step portion 431A of the first side wall 431 of the weight 43. That is, the second beam 532 is fixed to the vibrating body 40 via the second fixing portion 52.

The first fixing portion 51 is connected to an end portion of the first beam 531 away from the connection portion 533. The first fixing portion 51 is fixed to an inner wall surface of the fourth side portion 124 of the cover 12. That is, the first beam 531 is connected to the casing via the first fixing portion 51. Thus, the elastic member 50 is disposed between the stationary portion and the vibrating body 40.

The top plate portion 54 is connected to an end portion of the second fixing portion 52 away from the plate spring portion 53 via the first connection portion 56. The first connection portion 56 has a shape that is bent so as to extend from the second fixing portion 52 first in the upward direction and then in the second direction. The first connection portion 56 is connected to one end portion of one edge of the top plate portion 54 extending in the first direction. The top plate portion 54 is disposed above the vibrating body 40. The top plate portion 54 is more elongated in the first direction than in the second direction and faces the magnets 41 and 42 in the up-down direction. The top plate portion 54 is used as a back yoke for suppressing leakage of magnetic flux between the magnets 41 and 42.

The flat plate portion 55 is connected to the end portion of the second fixing portion 52 away from the plate spring portion 53 via the second connection portion 57. The second connection portion 57 has a shape that is bent so as to first separate from the second fixing portion 52 in the first direction and then approach the second fixing portion 52. Thus, the flat plate portion 55, which is connected to the second connection portion 57, faces the second fixing portion 52 in the second direction.

The elastic member 60 has the same structure as the elastic member 50. The elastic member includes a first fixing portion 61, a second fixing portion 62, a plate spring portion 63, a top plate portion 64, and a flat plate portion 65. The second fixing portion 62 is fixed to the step portion 432A of the second side wall 432 of the weight 43. The first fixing portion 61 is fixed to an inner wall surface of the third side portion 123 of the cover 12. Thus, the vibrating body 40 is supported by the elastic members 50 and 60 so as to be vibratable in the first direction (one direction) relative to the stationary portion.

A part of the substrate 21, the coil 31, the vibrating body 40, and the elastic members 50 and 60 are disposed in an inner space formed by the cover 12 and the base 11.

In the vibration motor 100 having such a structure, an electric current is supplied to the coil 31 through wires in the substrate 21. When the electric current flows through the coil 31, the vibrating body 40 vibrates in the first direction due to interaction between a magnetic field generated by the coil 31 and a magnetic field generated by the magnets 41 and 42.

### 1-2. Process of Manufacturing Vibration Motor

A process of manufacturing the vibration motor 100 will be described. First, a step of fixing the elastic member to the cover and the weight will be described.

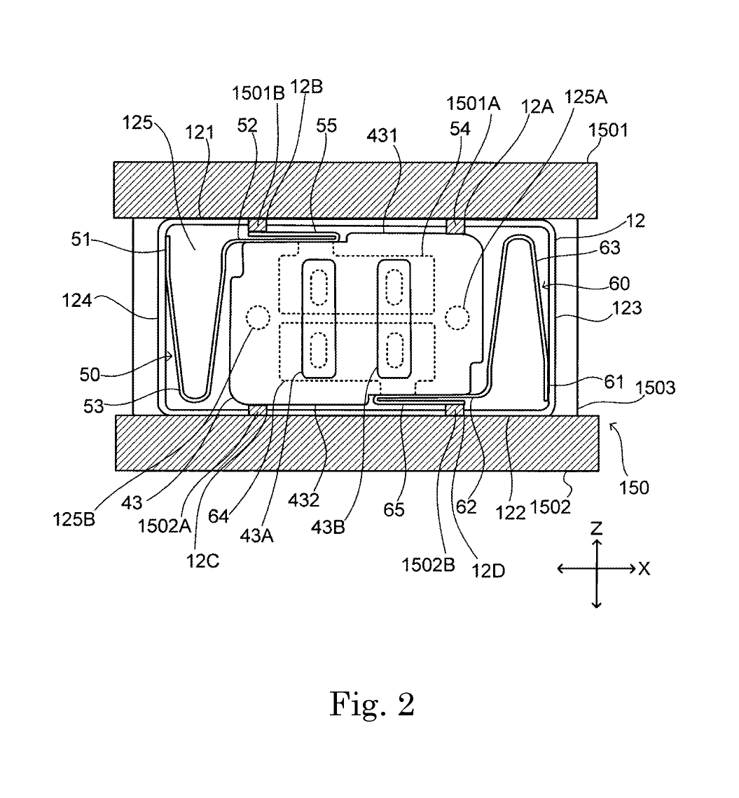

FIG. 2 illustrates a state in which the weight 43 is held by a jig 150 when fixing the elastic members 50 and 60 to the cover 12 and the weight 43. FIG. 2 is a plan view seen from below in the up-down direction.

The cover 12 has first openings 12A and 12B, which are formed in the first side portion 121 and arranged in the first direction. The first openings 12A and 12B face the first side wall 431 of the weight 43. That is, the cover 12 has at least one first opening that faces the first side wall 431. The first openings 12A and 12B each have a cutout shape whose bottom is open. Alternatively, the first openings 12A and 12B may each have a hole-like shape.

The cover 12 has second openings 12C and 12D, which are formed in the second side portion 122 and arranged in the first direction. The second openings 12C and 12D face the second side wall 432 of the weight 43. That is, the cover 12 has at least one second opening that faces the second side wall 432. The second openings 12C and 12D each have a cutout shape whose bottom is open. Alternatively, the second openings 12C and 12D may each have a hole-like shape.

The first opening 12A directly faces the first side wall 431. That is, no member is present between the first opening 12A and the first side wall 431. The second opening 12C directly faces the second side wall 432. That is, no member is present between the second opening 12C and the second side wall 432. That is, at least one of at least either of the first opening and the second opening directly faces the first side wall or the second side wall.

The first opening 12B faces the first side wall 431 with the second fixing portion 52 and the flat plate portion 55 therebetween. The second opening 12D faces the second side wall 432 with the second fixing portion 62 and the flat plate portion 65 therebetween. That is, at least one of at least either of the first opening and the second opening faces the first side wall or the second side wall with the second fixing portion and the flat plate portion therebetween.

The jig 150 includes a first side wall pillar 1501, a second side wall pillar 1502, and a base member 1503. The first side wall pillar 1501 and the second side wall pillar 1502 are disposed at both ends of the base member 1503 so as to extend downward in the second direction (toward positions in front of the plane of FIG. 2). The first side wall pillar 1501 includes first protrusions 1501A and 1501B, which are arranged in the first direction. The first protrusions 1501A and 1501B protrude in the second direction. The second side wall pillar 1502 includes second protrusions 1502A and 1502B, which are arranged in the first direction. The second protrusions 1502A and 1502B protrude in the second direction. The first protrusions 1501A and 1501B and the second protrusions 1502A and 1502B protrude in directions such that the protrusions 1501A and 1502B face each other and the protrusions 1501B and 1502A face each other.

In the manufacturing process, the cover 12 is disposed on the base member 1503. At this time, pins (not shown) that are disposed on the base member 1503 and arranged in the first direction are inserted into the holes 125A and 125B formed in the top portion 125 of the cover 12; and thereby the weight 43, which is disposed in the cover 12, is supported by the pins. Thus, it is possible to control a gap between the weight 43 and the top portion 125. In a state in which the weight 43, the elastic member 50, and the elastic member 60 are disposed in the cover 12, the first side wall pillar 1501 and the second side wall pillar 1502 are moved closer to the cover 12 from both sides in the second direction. Then, the first protrusion 1501A is inserted into the first opening 12A, and the first protrusion 1501B is inserted into the first opening 12B. At the same time, the second protrusion 1502A is inserted into the second opening 12C, and the second protrusion 1502B is inserted into the second opening 12D.

Thus, the first protrusion 1501A directly contacts the first side wall 431 through the first opening 12A, and the second protrusion 1502A directly contacts the second side wall 432 through the second opening 12C. The first protrusion 1501B contacts the flat plate portion 55 through the first opening 12B, and the second protrusion 1502B contacts the flat plate portion 65 through the second opening 12D. Accordingly, the weight 43 and the elastic member 50 and 60 are held by the first side wall pillar 1501 and the second side wall pillar 1502. Since the two protrusions directly contact the weight 43, it is possible to hold the weight 43 securely. Since the other two protrusions also contact the flat plate portions, it is possible to hold the weight 43 more securely.

The first opening 12A and the second opening 12C are disposed at positions that are displaced from each other in the first direction from positions that face each other in the second direction. The first opening 12B and the second opening 12D are disposed at positions that are displaced from each other in the first direction from positions that face each other in the second direction. Thus, when holding the weight 43, it is possible to suppress rotation of the weight 43 around an axis extending in the second direction.

By holding the weight 43 and the elastic member 50 and 60 as described above, it is easy to precisely control a small gap between the weight 43 and an inner wall surface of the first side portion 121 or the second side portion 122 of the cover 12. For example, it is possible to control the gap to 0.2 mm.

In the state in which the weight 43 and the elastic member 50 and 60 are held as described above, the first fixing portion 51 is fixed to the fourth side portion 124 of the cover 12 by welding from the first direction, and the first fixing portion is fixed to the third side portion 123 of the cover 12 by welding from the first direction.

In the holding state described above, the second fixing portion 52, the flat plate portion 55, and the weight 43 are fixed to each other by welding from below (from a position in front of the plane of FIG. 2); and the second fixing portion 62, the flat plate portion 65, and the weight 43 are fixed to each other by welding from below. In a stable state in which the flat plate portion and the second fixing portion are held by the first side wall pillar 1501 and the second side wall pillar 1502, it is easy to weld the elastic members 50 and 60 to the weight 43. By holding the flat plate portion and the second fixing portion, it is possible to fix the elastic members 50 and 60 to both of the weight 43 and the cover 12. As a result, manufacturing efficiency is improved.

Since the flat plate portions 55 and 65 are connected to the second fixing portions 52 and 62, it is possible to provide the elastic member with a sufficient thickness for welding without using a plate member or the like that is independent from the elastic member, and it is easy to hold the flat plate portion and the second fixing portion by using the jig 150.

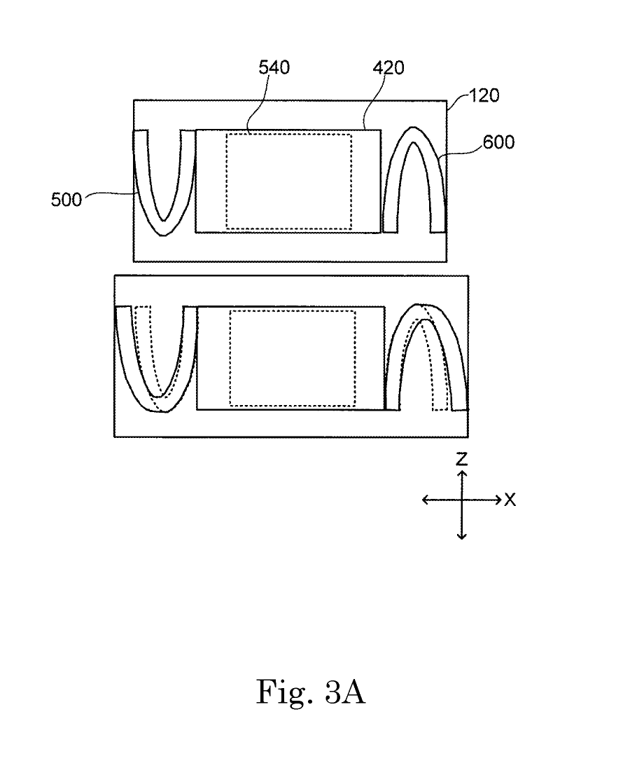

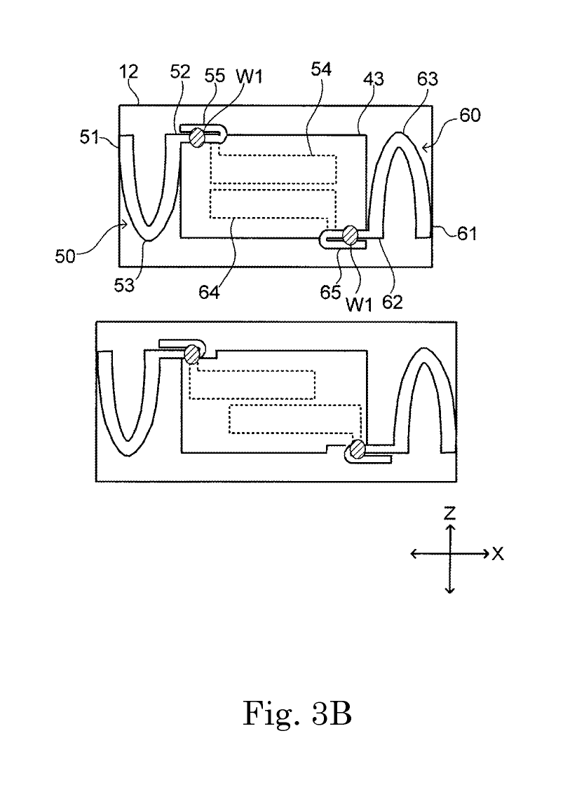

FIG. 3A illustrates a method of fixing of elastic members 500 and 600 to a cover 120 and a weight 420 in a process of manufacturing a vibration motor according to a comparative example, which is used for comparison with the present embodiment. FIG. 3A is a schematic plan view seen from below.

In FIG. 3A, a top plate portion 540 is independent from the elastic members 500 and 600 and disposed above the weight 420. The top plate portion 540 is fixed to the weight 420 by welding or the like. In a state in which the weight 420 is disposed in the cover 120, one end portions of the elastic members 500 and 600 are respectively fixed to inner wall surfaces of side portions of the cover 120 that face each other in the first direction by welding. The other end portions of the elastic members 500 and 600 are respectively fixed to side surfaces of the weight 420 that face each other in the first direction by welding.

In the upper part of FIG. 3A, because the width of the cover 120 in the first direction is a predetermined width, substantially no elastic force is applied to the elastic members 500 and 600 in an initial state in which the elastic members 500 and 600 are fixed. Due to lot-to-lot variation or the like, the length of the cover 120 in the first direction may vary within a tolerance. Because of such variation, the length of the cover 120 in the first direction in the lower part of FIG. 3A is slightly larger than that in the upper part of FIG. 3A.

In the lower part of FIG. 3A, it is necessary to fix one end portions of the elastic members 500 and 600 to the inner wall surfaces of the cover 120 by elastically deforming the elastic members 500 and 600 from the state shown in the upper part of FIG. 3A. Accordingly, in an initial state of the vibration motor, excessive forces are applied to the elastic members 500 and 600. When the vibration motor starts operating, larger forces are applied to the elastic members 500 and 600, and the elastic members 500 and 600 may break. Due to variation of the cover 120, the length of the cover 120 in the first direction may be slightly short. Also in this case, excessive forces are applied to the elastic members 500 and 600 in an initial state and in an operating state.

FIG. 3B illustrates a method of fixing of the elastic members 50 and 60 to the cover 12 and the weight 43 in the process of manufacturing the vibration motor 100 according to the present embodiment. FIG. 3B is a schematic plan view seen from below.

The top plate portion 54, which is connected to the second fixing portion 52, is integrated with the elastic member 50. Likewise, the top plate portion 64, which is connected to the second fixing portion 62, is integrated with the elastic member 60. Thus, as illustrated in the upper part and the lower part of FIG. 3B, even if the length of the cover 12 in the first direction varies within a tolerance, by adjusting the positions of the elastic members 50 and 60 in the first direction, it is possible to fix the first fixing portions 51 and 61 of the elastic members 50 and 60 to the inner wall surfaces of the cover 12 by welding and to fix the second fixing portions 52 and 62 of the elastic members 50 and 60 to the side surfaces of the weight 43 via welds W1. The welds W1 are formed by welding from below. Accordingly, irrespective of the length of the cover 12, it is possible to suppress application of excessive forces to the elastic members 50 and 60 and to suppress breakage of the elastic members 50 and 60 in an initial state of the vibration motor 100.

The elastic member 50 includes the flat plate portion 55. The flat plate portion 55, which is connected to the second fixing portion 52, faces the second fixing portion 52 in the second direction. Likewise, the elastic member 60 includes the flat plate portion 65, which is similar to the flat plate portion 55. A portion to be welded needs to have a sufficient thickness. With the structure in which the elastic members 50 and 60 include the flat plate portions, it is possible to provide a sufficient thickness to a portion to be welded and to perform welding without using an independent plate member or the like. Accordingly, it is possible to perform welding efficiently. Moreover, the flat plate portions can be easily formed by bending.

As described above, in a state in which the elastic members 50 and 60 are fixed to the cover 12 and the weight 43, the magnets 41 and 42 are fixed to the weight 43, and damper members (not shown) are fixed to the elastic members 50 and 60. Fixing of the magnets 41 and 42 and fixing of the damper members are performed by, for example, using an adhesive.

In a state in which the components are disposed in the cover 12 as described above, the cover 12 is fixed to the base 11, and thereby the vibration motor 100 is manufactured. A method of fixing of the cover 12 will be described in detail.

As illustrated in FIG. 1, the substrate 21 is disposed on the base 11. The coil 31 is disposed on the substrate 21. The base 11 includes a first edge portion 111, which extends in the first direction, and a second edge portion 112, which faces the first edge portion 111.

The first edge portion 111 includes first cutout portions 11A and 11B, which are arranged in the first direction. The second edge portion 112 includes second cutout portions 11C and 11D, which are arranged in the first direction.

The first side portion 121 of the cover 12 includes first protrusions 12E and 12F. The first protrusion 12E is located adjacent to and outward from the first opening 12A in the first direction and protrudes in the downward direction. The first protrusion 12F is located adjacent to and outward from the first opening 12B in the first direction and protrudes in the downward direction.

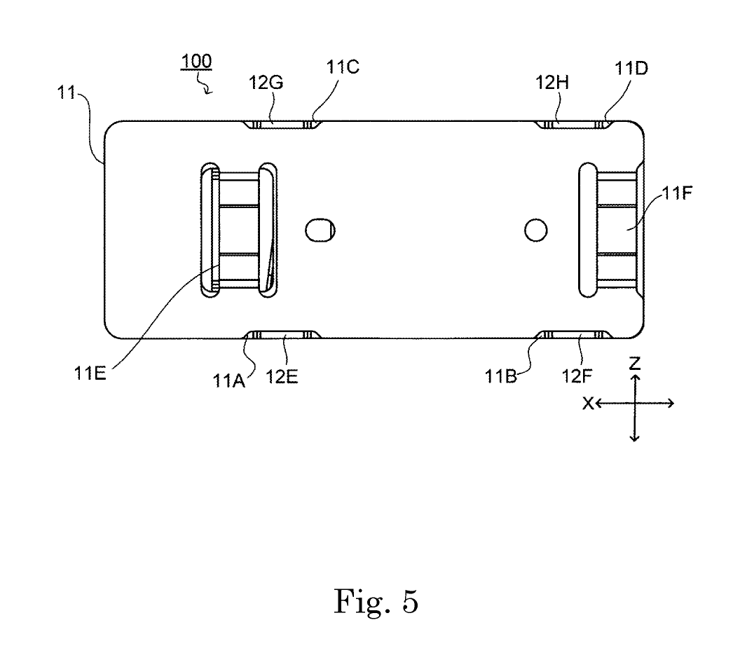

The second side portion 122 of the cover 12 includes two second protrusions 12G and 12H (shown in FIG. 5 as described below), which are have same structures as the first protrusions.

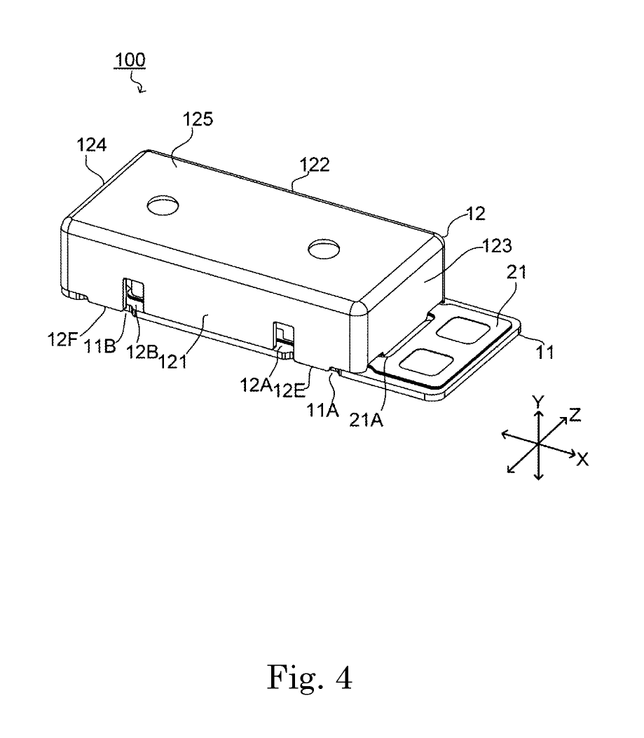

The cover 12 is attached to the base 11 so that the first protrusions 12E and 12F are respectively fitted into the first cutout portions 11A and 11B and the second protrusions 12G and 12H are respectively fitted into the second cutout portions 11C and 11D. FIG. 4 is a perspective view and FIG. 5 is a bottom view illustrating this state. Thus, it is possible to restrict movement of the cover 12 in the second direction and to position the cover 12 in the second direction.

As illustrated in FIG. 1, the base 11 includes a first raised portion 11E and a second raised portion 11F, which are raised in the upward direction and arranged in the first direction. The substrate 21 has a through-hole 21A. The first raised portion 11E extends through the through-hole 21A.

In a state in which the cover 12 is attached to the base 11 as described above, an inner wall surface of the third side portion 123 of the cover 12 is in contact with the first raised portion 11E, and an inner wall surface of the fourth side portion 124 is in contact with the second raised portion 11F. Thus, it is possible to restrict movement of the cover 12 in the first direction and to position the cover 12 in the first direction.

As illustrated in FIG. 4, in the state in which the cover 12 is attached to the base 11, a part of the substrate 21 protrudes out of the cover 12. That is, although the substrate 21 has a shape that extends to the outside of the cover 12 in the first direction, by forming the through-hole 21A, it is possible to raise the first raised portion 11E while avoiding interference with the substrate 21.

The cover 12 is fixed to the base 11 by performing welding in the state in which the cover 12 is attached to the base 11, and thereby the vibration motor 100 is completed.

### 2. Second Embodiment

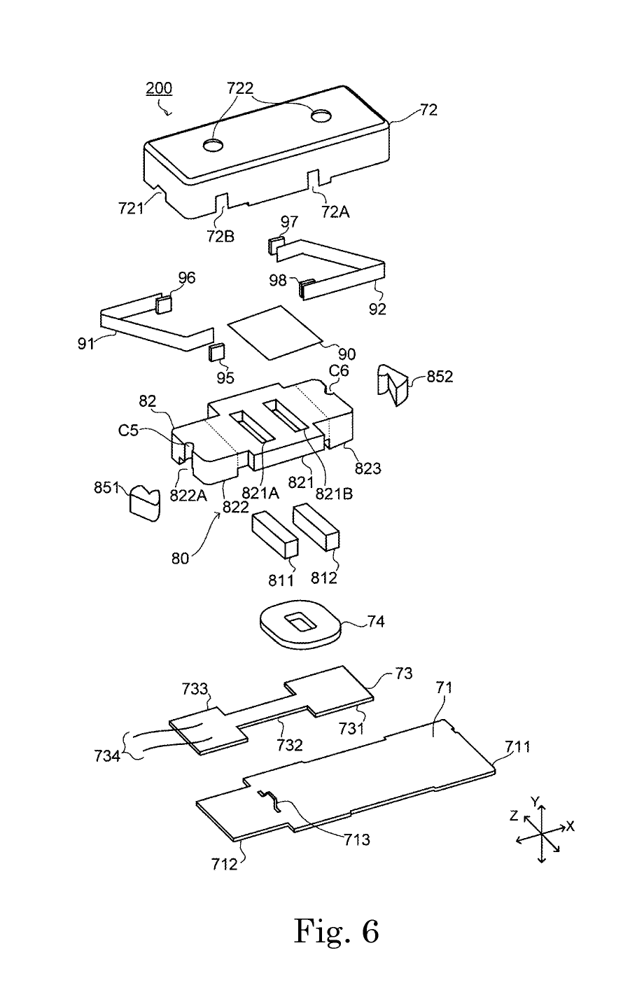

Next, a second embodiment of the present invention will be described. FIG. 6 is an exploded perspective view of a vibration motor 200 according to the second embodiment of the present invention.

The vibration motor 200 illustrated in FIG. 6 includes a base 71, a cover 72, a substrate 73, a coil 74, a vibrating body 80, damper members 851 and 852, a top plate portion 90, elastic members 91 and 92, and reinforcement plates 95 to 98.

The base 71 and the substrate 73 extend in the first direction (X-direction). The substrate 73 is disposed on the base 71. The coil 74 is disposed on the substrate 73. The base 71 and the cover 72 constitute a casing. The casing, the substrate 73, and the coil 74 constitute a stationary portion. That is, the vibration motor 200 includes a stationary portion that includes the casing and the coil 74.

The vibrating body 80 includes magnets 811 and 812 and a weight 82. The weight 82 is made of, for example, a tungsten alloy. The weight 82 includes a first weight portion 821 and second weight portions 822 and 823. The second weight portions 822 and 823 are respectively disposed so as to be continuous with both ends of the first weight portion 821 in the one direction. The first weight portion 821 has hollow portions 821A and 821B, which extend through the first weight portion 821 in the up-down direction. The magnet 811 is disposed in the hollow portion 821A. The magnet 812 is disposed in the hollow portion 821B. The magnets 811 and 812 are disposed above the coil 74.

The damper members 851 and 852 are made of, for example, foamed rubber (rubber sponge). The damper members 851 and 852 are fixed to both end surfaces of the weight 82 in the first direction.

The top plate portion 90 is independent from the elastic members 91 and 92. The top plate portion 90 faces the magnets 811 and 812 in the up-down direction and functions as a back yoke. The top plate portion 90 is fixed to the upper surface of the weight 82, for example, by welding or adhesive bonding.

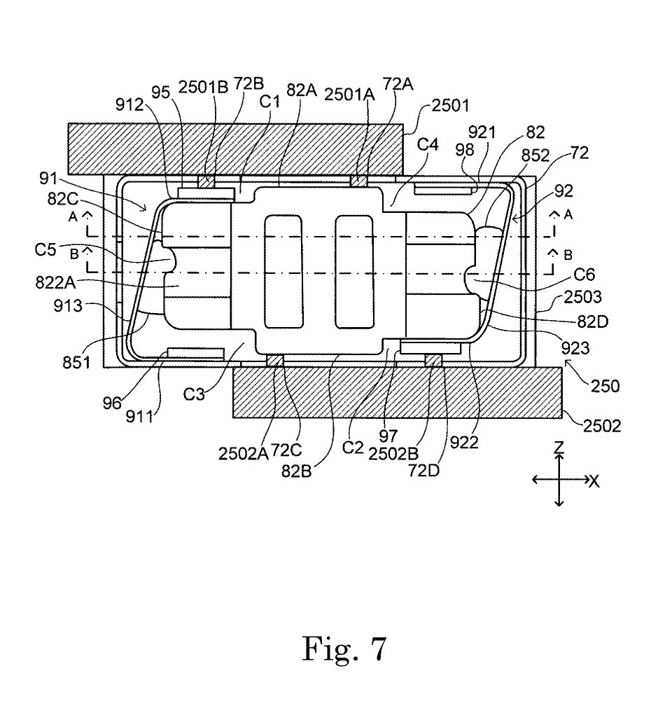

Referring to FIG. 7, a structure for fixing the elastic members 91 and 92, the weight 82, and the cover 72 to each other will be described in detail. FIG. 7 illustrates a state in which the weight 82 is held by a jig 250 when fixing the elastic members 91 and 92 to the cover 72 and the weight 82. FIG. 7 is a plan view seen from below in the up-down direction.

The elastic member 91 includes a first fixing portion 911, a second fixing portion 912, and a connection portion 913. The elastic member 92 includes a first fixing portion 921, a second fixing portion 922, and a connection portion 923.

The weight 82 includes side walls 82A to 82D. The side wall 82B faces the side wall 82A, which extends in the first direction. The side walls 82C and 82D each connect the side wall 82A to the side wall 82B.

The cover 72 has first openings 72A and 72B, which face the side wall 82A. The cover 72 also has second openings 72C and 72D, which face the side wall 82B. The first opening 72A and the second opening 72C directly face the side wall 82A and the side wall 82B, respectively.

The first opening 72B faces the side wall 82A with the second fixing portion 912 and the reinforcement plate 95 therebetween. The second opening 72D faces the side wall 82B with the second fixing portion 922 and the reinforcement plate 97 therebetween. The reinforcement plates 95 and 97 are examples of a flat plate portion.

The jig 250 includes a first side wall pillar 2501, a second side wall pillar 2502, and a base member 2503. The first side wall pillar 2501 includes first protrusions 2501A and 2501B, which are arranged in the first direction. The second side wall pillar 2502 includes second protrusions 2502A and 2502B, which are arranged in the first direction.

In the manufacturing process, the cover 72 is disposed on the base member 2503. At this time, pins (not shown) that are disposed on the base member 2503 and arranged in the first direction are inserted into holes 722 (see FIG. 6), which are formed in the top portion of the cover 72; and thereby the weight 82, which is disposed in the cover 72, is supported by the pins. Thus, it is possible to control a gap between the weight 82 and the top portion of the cover 72. In the state in which the weight 82, the elastic members 91 and 92, and the reinforcement plates 95 and 97 are disposed in the cover 72, the first side wall pillar 2501 and the second side wall pillar 2502 are moved closer to the cover 72 from both sides in the second direction. Then, the first protrusion 2501A is inserted into the first opening 72A, and the first protrusion 2501B is inserted into the first opening 72B. At the same time, the second protrusion 2502A is inserted into the second opening 72C, and the second protrusion 2502B is inserted into the second opening 72D.

Thus, the first protrusion 2501A directly contacts the side wall 82A through the first opening 72A, and the second protrusion 2502A directly contacts the side wall 82B through the second opening 72C. The first protrusion 2501B contacts the reinforcement plate 95 through the first opening 72B, and the second protrusion 2502B contacts the reinforcement plate 97 through the second opening 72D. Accordingly, the weight 82, the elastic members 91 and 92, and the reinforcement plates 95 and 97 are held by the first side wall pillar 2501 and the second side wall pillar 2502. Since the two protrusions directly contact the weight 82, it is possible to hold the weight 82 securely. Since the other two protrusions also contact the reinforcement plates 95 and 97, it is possible to hold the weight 82 more securely.

The first opening 72A and the second opening 72C are disposed at positions that are displaced from each other in the first direction from positions that face each other in the second direction. The first opening 72B and the second opening 72D are disposed at positions that are displaced from each other in the first direction from positions that face each other in the second direction. Thus, when holding the weight 82, it is possible to suppress rotation of the weight 82 around an axis extending in the second direction.

By holding the weight 82, the elastic member 91 and 92, and the reinforcement plates 95 and 97 as described above, it is easy to precisely control a small gap between the weight 82 and the inner wall surface of the cover 72.

In the state in which the weight 82, the elastic member 91 and 92, and the reinforcement plates 95 and 97 are held as described above, the first fixing portion 911 and the reinforcement plate 96 are fixed to a side portion of the cover 72 by welding from the first direction, and the first fixing portion 921 and the reinforcement plate 98 are fixed to a side portion of the cover 72 by welding from the first direction. To allow the welding to be performed in the first direction, the first side wall pillar 2501 is not disposed at a position facing the first fixing portion 921, and the second side wall pillar 2502 is not disposed at a position facing the first fixing portion 911.

In the holding state described above, the second fixing portion 912, the reinforcement plate 95, and the weight 82 are fixed to each other by welding from below (from a position in front of the plane of FIG. 7); and the second fixing portion 922, the reinforcement plate 97, and the weight 82 are fixed by welding from below.

The first fixing portion 911 is fixed to a wall surface of the cover 72 that faces one end portion of the side wall 82B in the first direction. A recessed portion C1 is formed in one end portion of the side wall 82A in the first direction in such a way that a part of the side wall 82A including a corner is cut out. The second fixing portion 912 is fixed to the recessed portion C1. The connection portion 913 connects the first fixing portion 911 to the second fixing portion 912 and is located on one side of the side wall 82C in the first direction.

The first fixing portion 921 is fixed to a wall surface of the cover 72 that faces the other end portion of the side wall 82A in the first direction. The positions to which the first fixing portions 911 and 921 are fixed are located diagonal to each other. A recessed portion C2 is formed in the other end portion of the side wall 82B in the first direction in such a way that a part of the side wall 82B including a corner is cut out. The recessed portions C1 and C2 are located diagonal to each other. The second fixing portion 922 is fixed to the recessed portion C2. The connection portion 923 connects the first fixing portion 921 to the second fixing portion 922 and is located on one side of the side wall 82D in the first direction. That is, the elastic members and 92 are located between the stationary portion and the vibrating body 80.

By thus fixing the second fixing portion 912 to the recessed portion C1 and fixing the second fixing portion 922 to the recessed portion C2, it is possible to reduce the width of the cover 72 in the second direction while minimizing reduction in the weight of the weight 82. Accordingly, the size of the vibration motor 200 can be reduced.

With the structure for fixing the elastic members 91 and 92 to the cover 72 and to the weight 82, the vibrating body 80 is supported so as to be vibratable in the first direction relative to the stationary portion. When an electric current flows though the coil 74, the vibrating body 80 vibrates in the first direction due to interaction between a magnetic field generated by the coil 74 and a magnetic field generated by the magnets 811 and 812.

Referring again to FIG. 7, the reinforcement plate 95 is fixed to the second fixing portion 912. Thus, the reinforcement plate 95 is disposed in the recessed portion C1, and therefore it is possible to reinforce the second fixing portion 912 without increasing the width of the cover 72 in the second direction. Likewise, the reinforcement plate 97 is fixed to the second fixing portion 922 and disposed in the recessed portion C2.

The reinforcement plate 96 is fixed to the first fixing portion 911. A recessed portion C3 is formed in an end portion of the side wall 82B in the first direction away from the recessed portion C2 in such a way that a part of the side wall 82B including a corner is cut out. The reinforcement plate 96 is disposed in the recessed portion C3. The reinforcement plate 96 has a function of reinforcing the first fixing portion 911 and a function of restraining the position of the weight 82 so that the elastic member 91 may not break due to excessive movement of the weight 82 in the first direction when the vibration motor 200 drops.

Likewise, the reinforcement plate 98 is fixed to the first fixing portion 921. A recessed portion C4 is formed in an end portion of the side wall 82A in the first direction away from the recessed portion C1 in such a way that a part of the side wall 82A including a corner is cut out. The reinforcement plate 98 is disposed in the recessed portion C4. The reinforcement plate 98 has a function of reinforcing the first fixing portion 921 and a function of restraining the position of the weight 82 so that the elastic member 92 may not break due to excessive movement of the weight 82 in the first direction when the vibration motor 200 drops.

Next, a structure related to the damper members 851 and 852 will be described. The damper member 851 is disposed between the connection portion 913 and the side wall 82C. The damper member 852 is disposed between the connection portion 923 and the side wall 82D. Thus, it is possible to effectively damp the vibration of the vibrating body 80 when supply of electric current to the coil 74 is stopped. By providing the vibration motor with the damper members, compared with a case where they are not provided, it is possible to considerably shorten the period from the time when supply of electric current to the coil 74 is stopped to the time when the amplitude of the vibration of the vibrating body 80 becomes zero.

A recessed portion C5 is formed in the side wall 82C, and a recessed portion C6 is formed in the side wall 82D. The recessed portions C5 and C6 extend through the side walls 82C and 82D in the up-down direction. However, for example, the recessed portions C5 and C6 need not extend through upper end portions of the side walls 82C and 82D. Parts of the damper members 851 and 852 are respectively disposed in the recessed portions C5 and C6. Thus, it is possible to suppress removal of the damper members 851 and 852.

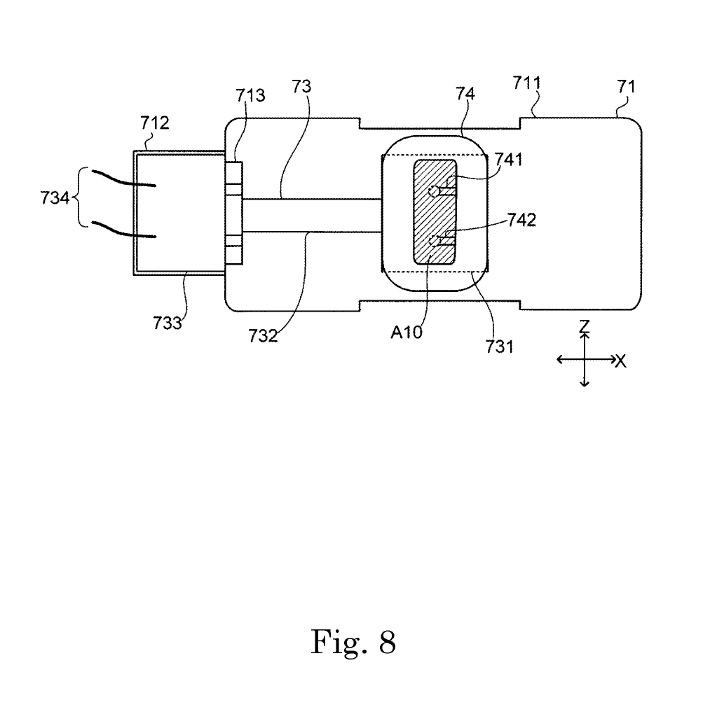

FIG. 8 is a plan view illustrating a structure including the base 71 and adjacent components seen from above. The base 71 includes a first plate portion 711 and a second plate portion 712. The second plate portion 712 protrudes in the first direction from one end portion of the first plate portion 711 in the first direction.

The substrate 73 includes a substrate body 731, an extension portion 732, a wide portion 733, and two lead wires 734. The coil 74 is placed on the substrate body 731. The extension portion 732 extends from the substrate body 731 in the first direction. The wide portion 733 is connected to one end portion of the extension portion 732 in the first direction. The width of the wide portion 733 in the second direction is larger than that of the extension portion 732. The lead wires 734 extend from the wide portion 733.

The substrate body 731 and the extension portion 732 are disposed on the first plate portion 711. The wide portion 733 is disposed on the second plate portion 712. The boundary between the extension portion 732 and the wide portion 733 is disposed on the outer edge of one end portion of the first plate portion 711 in the first direction. The base 71 includes a raised portion 713, which is raised upward. The raised portion 713 is independent from the first plate portion 711 and fixed to the first plate portion 711 at the boundary between the extension portion 732 and the wide portion 733. The raised portion 713 is fixed to the first plate portion 711 by, for example, welding.

The raised portion 713 has a through-hole that extends in the first direction. The extension portion 732 extends through the through-hole. Thus, the raised portion 713 restricts upward lifting of the extension portion 732, and it is possible to suppress breakage of wires in the extension portion 732 due to contact with the vibrating body 80.

If the extension portion 732 extends to the position of the wide portion 733 while maintaining its width, it is possible to insert the extension portion 732 into the raised portion 713 even if the raised portion 713 is formed by cutting an raising the base 71.

A cutout portion 721 is formed in one end surface of the cover 72 in the first direction so as to correspond to the raised portion 713 (see FIG. 6). The cover 72 is attached to the first plate portion 711 so that the cutout portion 721 covers the raised portion 713 from above. Thus, the substrate body 731, the extension portion 732, the coil 74, the vibrating body 80, the damper members 851 and 852, the top plate portion 90, the elastic members 91 and 92, and the reinforcement plates 95 to 98 are disposed in the space surrounded by the cover 72 and the first plate portion 711.

That is, the extension portion 732 extends from the substrate body 731 to the outside of the casing in the first direction, and the wide portion 733 and the lead wires 734 are disposed outside of the casing. Alternatively, the extension portion may extend in the second direction from the substrate body 731 to the outside of the casing.

The coil 74 includes lead wires 741 and 742. The lead wires 741 and 742 are connected to electrodes of the substrate body 731 at positions inside of the coil 74 by soldering or the like. Thus, it is possible to suppress breakage of the lead wires 741 and 742 due to contact with the vibrating body 80 that may occur if the lead wires 741 and 742 extend to the outside of the coil 74. The lead wires 734 are electrically connected to the coil 74, and a voltage can be applied from the outside to the coil 74 through the lead wires 734.

An adhesive portion A10 is formed inside of the coil 74 by filling the inside of the coil 74 with an adhesive and curing the adhesive. Thus, it is possible to suppress breakage of the lead wires 741 and 742 that may occur if the lead wires 741 and 742 are lifted upward and contact the vibrating body 80.

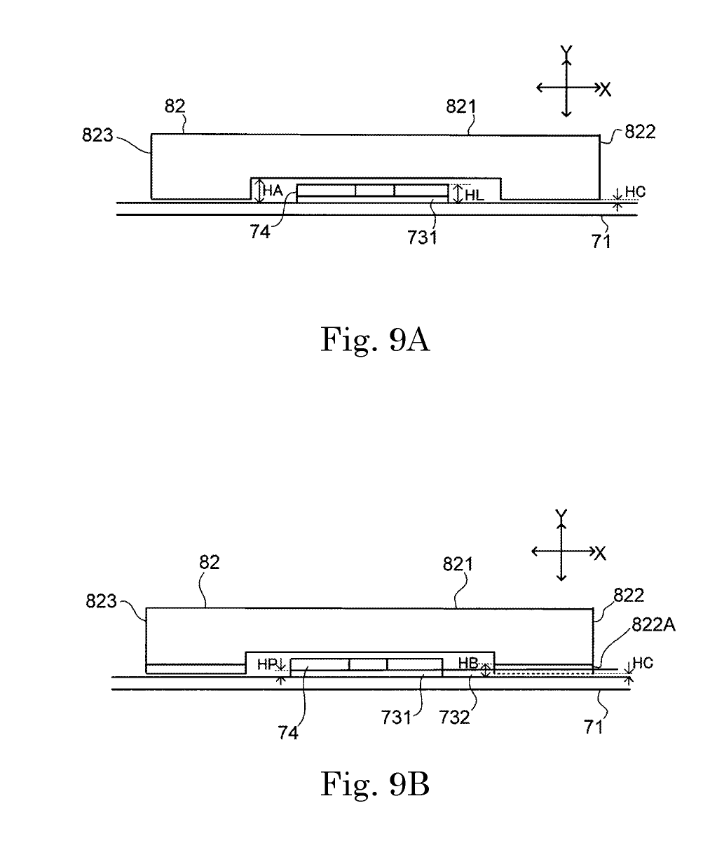

FIG. 9A is a partial sectional view of the vibration motor 200 taken along line IXA-IXA in FIG. 7. FIG. 9B is a partial sectional view of the vibration motor 200 taken along line IXB-IXB in FIG. 7.

In the weight 82, the second weight portions 822 and 823 are disposed adjacent to both ends of the first weight portion 821 in the first direction. The first weight portion 821 is disposed above the coil 74. The lower surfaces of the second weight portions 822 and 823 are located below the lower surface of the first weight portion 821. Lower parts of the second weight portions 822 and 823 face the coil 74 in the first direction. Thus, even if the second weight portions 822 and 823 move downward due to dropping of the vibration motor 200 or the like, the second weight portions 822 and 823 contact the base 71 before the first weight portion 821 contacts the coil 74. Accordingly, it is possible to suppress breakage of the coil 74 due to contact with the first weight portion 821.

A groove 822A, which extends in the first direction, is formed in a lower part of the second weight portion 822. The extension portion 732 is disposed in the groove 822A. Thus, even if the weight 82 moves downward due to dropping of the vibration motor 200 or the like, it is possible to suppress contact of the weight 82 with the extension portion 732.

Let HA denote the height from the base 71 to the lower surface of the first weight portion 821, HB denote the height from the base 71 to the groove 822A, HL denote the height from the base 71 to the upper surface of the coil 74, and HP denote the height from the base 71 to the upper surface of the substrate 73. Then, in the present embodiment, a relationship HA>HL>HB>HP is satisfied. Another relationship HA>HB>HL may be satisfied. However, it is possible to minimize HB when the former relationship is satisfied. That is, the depth of the groove 822A can be made smaller, and the weight 82 can have sufficient weight.

In addition to the above relationship, in the present embodiment, a relationship HP≧HC is satisfied, where HC is the height from the base 71 to the lower surface of the second weight portion 822. Thus, it is possible to minimize HC and to increase the distance between the lower surface of the second weight portion 822 and the lower surface of the first weight portion 821. As a result, the weight 82 can have sufficient weight.

### 3. Modification of Second Embodiment

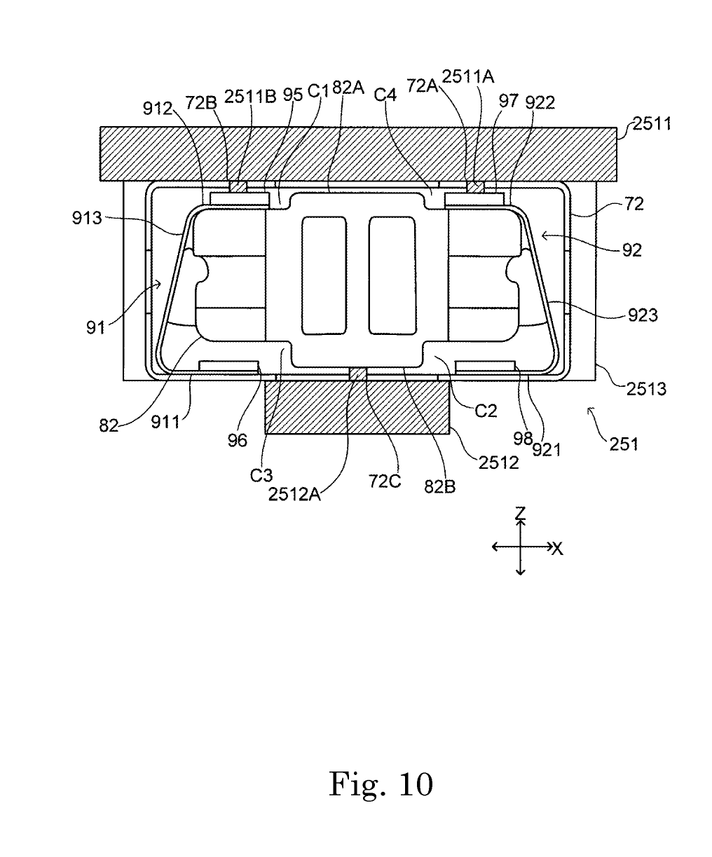

A modification of the second embodiment will be described. FIG. 10 is a plan view illustrating a state in which the weight 82 is held by a jig 251 when fixing the elastic members and 92 to the cover 72 and the weight 82 according to the modification the second embodiment. FIG. 10 is a plan view seen from below in the up-down direction and corresponding to FIG. 7.

The cover 72 has the first openings 72A and 72B, which face the side wall 82A. The cover 72 also has the second opening 72C, which faces the side wall 82B.

The first opening 72A faces the side wall 82A with the second fixing portion 922 and the reinforcement plate 97 therebetween. The first opening 72B faces the side wall 82A with the second fixing portion 912 and the reinforcement plate 95 therebetween. The reinforcement plates 95 and 97 are examples of a flat plate portion. The second opening 72C directly faces the side wall 82B.

The jig 251 includes a first side wall pillar 2511, a second side wall pillar 2512, and a base member 2513. The first side wall pillar 2511 includes first protrusions 2511A and 2511B, which are arranged in the first direction. The second side wall pillar 2512 includes a second protrusion 2512A.

In the manufacturing process, the cover 72 is disposed on the base member 2513. In the state in which the weight 82, the elastic members 91 and 92, and the reinforcement plates 95 and 97 are disposed in the cover 72, the first side wall pillar 2511 and the second side wall pillar 2512 are moved closer to the cover 72 from both sides in the second direction. Then, the first protrusion 2511A is inserted into the first opening 72A, and the first protrusion 2511B is inserted into the first opening 72B. At the same time, the second protrusion 2512A is inserted into the second opening 72C.

Thus, the second protrusion 2512A directly contacts the side wall 82B through the second opening 72C. The first protrusion 2511B contacts the reinforcement plate 95 through the first opening 72B, and the first protrusion 2511A contacts the reinforcement plate 97 through the first opening 72A. Accordingly, the weight 82, the elastic members 91 and 92, and the reinforcement plates 95 and 97 are held by the first side wall pillar 2511 and the second side wall pillar 2512.

In the state in which the weight 82, the elastic member 91 and 92, and the reinforcement plates 95 and 97 are held as described above, the first fixing portion 911 and the reinforcement plate 96 are fixed to a side portion of the cover 72 by welding from the second direction, and the first fixing portion 921 and the reinforcement plate 98 are fixed to a side portion of the cover 72 by welding from the second direction. To allow the welding to be performed in the second direction, the second side wall pillar 2512 is not disposed at positions facing the first fixing portions 911 and 921.

In the holding state described above, the second fixing portion 912, the reinforcement plate 95, and the weight 82 are fixed to each other by welding from below (from a position in front of the plane of FIG. 10); and the second fixing portion 922, the reinforcement plate 97, and the weight 82 are fixed by welding from below.

The modification illustrated in FIG. 10 differs from the second embodiment illustrated in FIG. 7 in the method of fixing the elastic members 91 and 92 to the weight 82. In the modification, the second fixing portion 912 of the elastic member 91 is fixed to the recessed portion C1 of the weight 82, and the second fixing portion 922 of the elastic member 92 is fixed to the recessed portion C4 of the weight 82. Since the recessed portions C1 and C4 are arranged in the first direction, the positions at which the second fixing portions 912 and 922 are fixed are arranged in the first direction. The reinforcement plate 95 is fixed to the second fixing portion 912 in the recessed portion C1, and the reinforcement plate 97 is fixed to the second fixing portion 922 in the recessed portion C4. Also with such a structure, the width of the cover 72 in the second direction can be reduced while maximizing the weight of the weight 82.

The first fixing portion 911 of the elastic member 91 is fixed to a wall surface of the cover 72 that faces the recessed portion C3, which faces the recessed portion C1 in the second direction. The reinforcement plate 96 is fixed to the first fixing portion 911 in the recessed portion C3. The first fixing portion 921 of the elastic member 92 is fixed to a wall surface of the cover 72 that faces the recessed portion C2, which faces the recessed portion C4 in the second direction. The reinforcement plate 98 is fixed to the first fixing portion 921 in the recessed portion C2. That is, the positions at which the first fixing portions 911 and 921 are fixed to the cover 72 are arranged in the first direction. The reinforcement plates 96 and 98 restrain movement of the weight 82 in the first direction and can suppress breakage of the elastic members 91 and 92 due to excessive movement of the weight 82.

### 4. Others

The embodiments of the present invention described above can be modified in various ways within the sprit and scope of the present invention.

For example, the structures of the first embodiment and the second embodiment may be used in combination as appropriate. For example, the structure of the weight in the second embodiment, which is constituted by the first weight portion and the second weight portion, may be used for the structure of the weight in the first embodiment. The structures of the base, the substrate, and the coil in the second embodiment may be used in the first embodiment.

The present invention can be used for a vibration motor that is included in, for example, a smartphone or a game pad.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vibration motor comprising:
a stationary portion including a casing and a coil;
a vibrating body including a weight and a magnet, the vibrating body being supported so as to be vibratable in one direction relative to the stationary portion; and
an elastic member located between the stationary portion and the vibrating body,
wherein the magnet is disposed above the coil in an up-down direction that is perpendicular to the one direction,
wherein the weight includes a first side wall extending in the one direction and a second side wall facing the first side wall, and
wherein the casing includes at least one first opening facing the first side wall and at least one second opening facing the second side wall.

2. The vibration motor according to claim 1,
wherein at least one of at least either of the first opening and the second opening directly faces the first side wall or the second side wall.

3. The vibration motor according to claim 2,
wherein the first opening that directly faces the first side wall and the second opening that directly faces the second side wall are disposed at positions that are displaced from each other in the one direction from positions that face each other in a direction that is perpendicular to the one direction and the up-down direction.

4. The vibration motor according to claim 3,
wherein the elastic member includes a fixing portion that is fixed to the first side wall or the second side wall, and
wherein at least one of at least either of the first opening and the second opening faces the first side wall or the second side wall with the fixing portion and a flat plate portion therebetween.

5. The vibration motor according to claim 4,
wherein the first opening that faces the first side wall with the fixing portion and the flat plate portion therebetween and the second opening that faces the second side wall with the fixing portion and the flat plate portion therebetween are disposed at positions that are displaced from each other in the one direction from positions that face each other in the direction that is perpendicular to the one direction and the up-down direction.

6. The vibration motor according to claim 5,
wherein the fixing portion is connected to the flat plate portion, and
wherein the elastic member includes the flat plate portion.

7. The vibration motor according to claim 6,
wherein the elastic member includes a top plate portion, and
wherein the top plate portion is disposed above the vibrating body in the up-down direction and connected to the fixing portion.

8. The vibration motor according to claim 7,
wherein the stationary portion further includes a substrate,
wherein the casing includes a base and a cover,
wherein the coil is disposed on the substrate,
wherein the substrate is disposed on the base,
wherein the base includes a first edge portion extending in the one direction and a second edge portion facing the first edge portion,
wherein the cover includes a first side portion extending in the one direction and a second side portion facing the first side portion,
wherein the first side portion includes a first protrusion protruding in a downward direction,
wherein the second side portion includes a second protrusion protruding in the downward direction,
wherein the first edge portion includes a first cutout portion into which the first protrusion is fitted, and
wherein the second edge portion includes a second cutout portion into which the second protrusion is fitted.

9. The vibration motor according to claim 8,
wherein the cover includes a third side portion extending in the direction that is perpendicular to the one direction and the up-down direction and a fourth side portion facing the third side portion,
wherein the base includes a first raised portion and a second raised portion that are raised in an upward direction and arranged in the one direction,
wherein the third side portion is in contact with the first raised portion, and
wherein the fourth side portion is in contact with the second raised portion.

10. The vibration motor according to claim 9,
wherein the substrate has a through-hole, and
wherein the first raised portion extends through the through-hole.

11. The vibration motor according to claim 10,
wherein the weight includes a first weight portion that is disposed above the coil and a second weight portion whose lower surface is located below a lower surface of the first weight portion, and
wherein the second weight portion faces the coil in the one direction.

12. The vibration motor according to claim 11,
wherein the substrate includes a substrate body on which the coil is disposed and an extension portion that extends from the substrate body in the one direction toward an outside of the casing, and
wherein the second weight portion includes a groove that extends in the one direction and in which the extension portion is disposed.

13. The vibration motor according to claim 12,
wherein a relationship HA>HL>HB>HP is satisfied, where HA is a height from the base to the lower surface of the first weight portion, HB is a height from the base to the groove, HL is a height from the base to an upper surface of the coil, and HP is a height from the base to an upper surface of the substrate.

14. The vibration motor according to claim 13,
wherein a relationship HP≧HC is satisfied, where HC is a height from the base to the lower surface of the second weight portion.

15. The vibration motor according to claim 14,
wherein a lead wire of the coil is connected to the substrate at a position inside of the coil.

16. The vibration motor according to claim 15,
wherein an adhesive portion is disposed inside of the coil.

17. The vibration motor according to claim 5,
wherein the elastic member includes a first fixing portion, a second fixing portion, and a connection portion,
wherein the weight includes a third side wall that connects the first side wall to the second side wall,
wherein a first recessed portion is formed in one end portion of the first side wall in the one direction in such a way that a part of the first side wall including a corner is cut out,
wherein the first fixing portion is fixed to a wall surface of the casing, the wall surface facing one end portion of the second side wall in the one direction,
wherein the second fixing portion is fixed to the first recessed portion, and
wherein the connection portion connects the first fixing portion to the second fixing portion and is located on one side of the third side wall in the one direction.

18. The vibration motor according to claim 17, further comprising:
a first reinforcement plate that is fixed to the second fixing portion.

19. The vibration motor according to claim 18, further comprising:
a second reinforcement plate that is fixed to the first fixing portion,
wherein a second recessed portion is formed in the one end portion of the second side wall in the one direction in such a way that a part of the second side wall including a corner is cut out, and
wherein the second reinforcement plate is disposed in the second recessed portion.

20. The vibration motor according to claim 19, further comprising:
a damper member,
wherein the damper member is disposed between the connection portion and the third side wall.

21. The vibration motor according to claim 20,
wherein a third recessed portion is formed in the third side wall, and
wherein a part of the damper member is disposed in the third recessed portion.

22. The vibration motor according to claim 21,
wherein the stationary portion includes a substrate,
wherein the casing includes a base,
wherein the substrate is disposed on the base,
wherein the substrate includes a substrate body on which the coil is disposed and an extension portion that extends from the substrate body in the one direction toward an outside of the casing,
wherein the base includes a raised portion that is raised in the up-down direction,
wherein the raised portion has a through-hole extending therethrough in the one direction, and
wherein the extension portion extends through the through-hole.

23. The vibration motor according to claim 22,
wherein the weight includes a first weight portion that is disposed above the coil and a second weight portion whose lower surface is located below a lower surface of the first weight portion, and
wherein the second weight portion faces the coil in the one direction.

24. The vibration motor according to claim 23,
wherein the second weight portion includes a groove that extends in the one direction and in which the extension portion is disposed.

25. The vibration motor according to claim 24,
wherein a relationship HA>HL>HB>HP is satisfied, where HA is a height from the base to the lower surface of the first weight portion, HB is a height from the base to the groove, HL is a height from the base to an upper surface of the coil, and HP is a height from the base to an upper surface of the substrate.

26. The vibration motor according to claim 25,
wherein a relationship HP≧HC is satisfied, where HC is a height from the base to the lower surface of the second weight portion.

27. The vibration motor according to claim 26,
wherein a lead wire of the coil is connected to the substrate at a position inside of the coil.

28. The vibration motor according to claim 27,
wherein an adhesive portion is disposed inside of the coil.

29. A method for manufacturing a vibration motor,
the vibration motor including
a stationary portion including a casing and a coil;
a vibrating body including a weight and a magnet, the vibrating body being supported so as to be vibratable in one direction relative to the stationary portion; and
an elastic member located between the stationary portion and the vibrating body,
wherein the magnet is disposed above the coil in an up-down direction that is perpendicular to the one direction,
wherein the weight includes a first side wall extending in the one direction and a second side wall facing the first side wall, and
wherein the casing includes at least one first opening facing the first side wall and at least one second opening facing the second side wall,
the method comprising:
a first step of holding the weight by inserting protrusions of a jig into the first opening and the second opening; and
a second step of fixing the elastic member and the casing to each other by welding in a state in which the weight is held.

30. The method according to claim 29,
wherein the elastic member includes a fixing portion that is to be fixed to the first side wall or the second side wall,
wherein, in the first step, one of the protrusions contacts a flat plate portion that is disposed between the first opening or the second opening and the fixing portion, and
wherein the method further includes a third step of fixing the fixing portion and the weight to each other by welding in the state in which the weight is held.

31. The method according to claim 30,
wherein the elastic member includes the flat plate portion that is connected to the fixing portion.

32. The method according to claim 31,
wherein the elastic member includes a top plate portion that is connected to the fixing portion, and
wherein the method further includes a fourth step of adjusting a position of the elastic member in the one direction.
